(19) United States
(12) Patent Application Publication
(10) Pub. No.: US 2018/0005522 A1
(43) Pub. Date: Jan. 4, 2018

(54) IoT/CLOUD ENABLED FASTER AMBULANCES

(71) Applicant: Intel Corporation, Santa Clara, CA (US)

(72) Inventors: Saranga P. Pogula, Bangalore (IN); Manoj Velayudha, Bangalore (IN); Kishor G. Kulkarni, Bangalore (IN); Yoshifumi Nishi, Beaverton, OR (US); David W. Browning, Beaverton, OR (US); Mark MacDonald, Beaverton, OR (US)

(73) Assignee: Intel Corporation, Santa Clara, CA (US)

(21) Appl. No.: 15/201,545

(22) Filed: Jul. 4, 2016

(51) Int. Cl. G08G 1/087

(52) U.S. Cl. CPC G08G 1/087

(57) ABSTRACT

Methods and apparatus relating to IoT (Internet of Things) and/or cloud enabled faster ambulances are described. In an embodiment, an IoT device overrides an operating state of an illumination device based at least in part on a wireless signal that indicates approachment of a moving object. The IoT device then cancels the override of the operating state of the illumination device based at least in part on an indication that the moving object has crossed a location of the illumination device. In one embodiment, cloud-based logic determines whether and/or when the IoT device causes the override of the operating state of the illumination device. Other embodiments are also disclosed and claimed.

### FIELD

The present disclosure generally relates to the field of electronics. More particularly, an embodiment relates to IoT (Internet of Things) and/or cloud enabled faster ambulances.

### BACKGROUND

Ambulance services provide out-of-hospital acute medical care and/or transport to a medical facility such as a hospital for those in need. In medical emergencies, the amount of time it takes an ambulance to reach a patient and/or transport a patient to a hospital can have a direct impact on the patient's survival chances.

Moreover, population density, topography, and other conditions (such as traffic) can have a significant effect on ambulance travel times. Consequently, there is often significant variation between the responsiveness of emergency medical services in various locales and countries. Unfortunately, many thousands of people die each year in western countries due to such delays. The situation is even worse in lesser developed countries.

One current solution is to allow ambulances to change the traffic lights with a remote control device. However, such remote control devices generally only work if they have a line-of-sight to traffic lights. This limits the range (e.g., due to distance limitations), security (e.g., where it may be easier to hack a line-of-sight device), and/or effectiveness of such remote control devices. For example, if an ambulance has to wait to trigger a traffic light change until it is within the line-of-sight range to the traffic signal, the ambulance would still have to wait for the existing traffic to clear (especially in congested metropolitan areas). This clearly affects the effectiveness of such devices.

Hence, reducing ambulance travel times can save many lives each year.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 provides a pictorial view of how an ambulance trip is enhanced in accordance with one embodiment.

FIGS. 2 and 3 illustrate flow diagrams for IoT and/or cloud enabled faster ambulance travel, according to some embodiments.

FIG. 4A illustrates communication between the ambulance IoT and a traffic light controller, according to an embodiment.

FIG. 4B illustrates deployment of IoT devices at street lights, according to an embodiment.

FIGS. 5 and 6 illustrate block diagrams of embodiments of computing systems, which may be utilized in various embodiments discussed herein.

FIGS. 7 and 8 illustrate various components of processors in accordance with some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

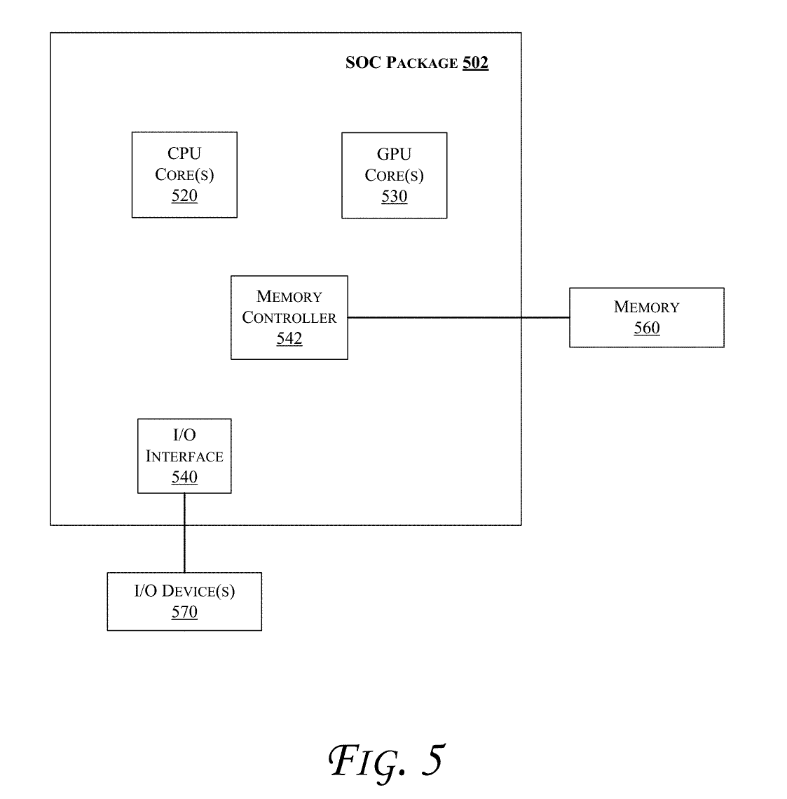

As mentioned above, reducing ambulance travel times will save many lives each year. To this end, some embodiments provide IoT (Internet of Things) and/or cloud enabled faster ambulances. In an embodiment, an “IoT device” generally refers to a device which includes electronic processing circuitry (such as one or more processor/cores, PLA (Programmable Logic Array), SoC, ASIC (Application Specific Integrated Circuit), etc.), memory (e.g., to store software or firmware), one or more sensors (or is otherwise coupled to one or more sensors such as a camera, motion detector, etc.), and network connectivity to allow the IoT device to collect and/or exchange data. IoT devices are generally cheaper than traditional computing devices to allow for their proliferation at remote locations. IoT devices also reduce costs by using existing infrastructure (such as the Internet, a (third generation (3G) or fourth generation (4G) cellular/wireless network, etc.). More generally, an IoT device may include one or more components such as those discussed with reference to FIGS. 5-8.

Additionally, while some embodiments are discussed with reference to ambulances, the embodiments are not limited to ambulances and may include any authorized vehicle such as emergency service vehicles (including vehicles carrying security/police staff, medical personnel, firefighters, etc.), and/or vehicles carrying dignitaries, sensitive content (such as organs for organ transplants operations and/or hazardous material), etc. In an embodiment, an IoT device is present on the authorized vehicle and on one or more (or all) traffic signals en route to the destination of the authorized vehicle. In one embodiment, the authorized vehicle may communicate through the cloud to reduce its travel time (or allow for safer passage) to its destination. One or more embodiments may utilize one or more cameras at the traffic signals, on the authorized vehicle (e.g., coupled to the IoT device), and/or other locations en route to assist in enforcement, address delay issues, etc. The infrastructure used in various embodiment can be very useful in characterizing which intersections or localities have more ambulance delays (or even deaths due to the delays). This can be achieved by the IoT device capturing still pictures and/or videos of the traffic conditions at the intersections. etc. and transmit them to the cloud. Police/city authorities can subsequently analyze the situations and take appropriate actions to improve such traffic conditions.

Accordingly, one or more embodiments address the issue of an on-duty ambulance (or other authorized vehicle) not being prioritized by traffic lights. Namely, a traffic signal being red in the ambulance route results in road-block and vehicle build up, slowing down the on-duty ambulance to its destination. Some current solutions include a manual way of accomplishing prioritization of ambulances at the traffic signal (as discussed above). Moreover, such solutions are not centrally managed, or securely authenticated. By contrast, at least one embodiment utilized IoT and/or cloud based technology to prioritize control of traffic signals e route to enable faster movement of ambulances (or other authorized vehicles) to their destination.

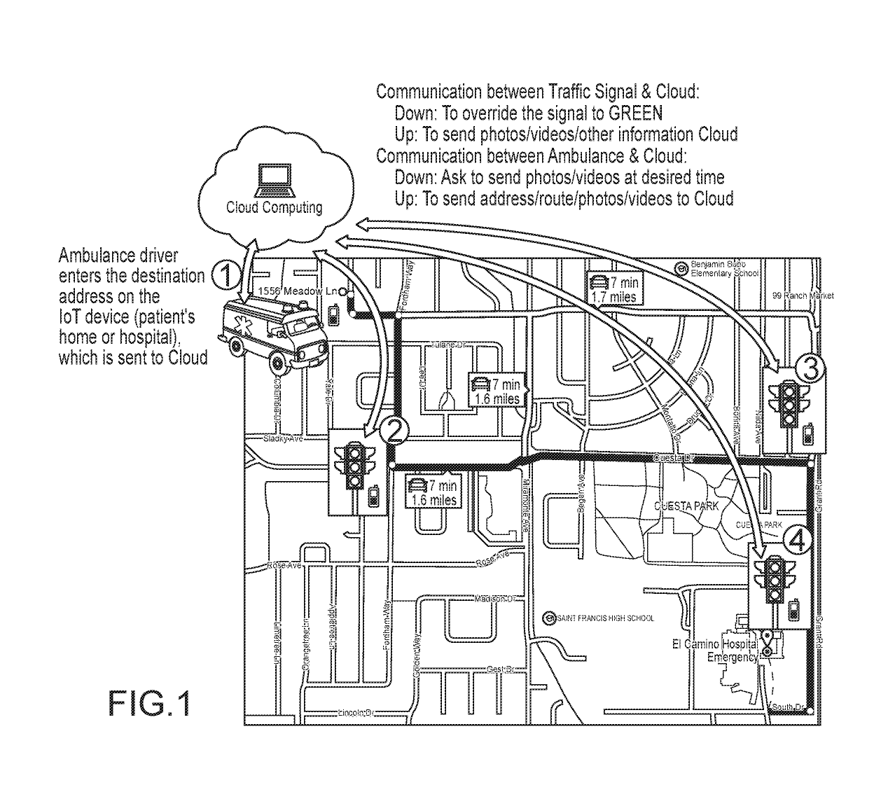

FIG. 1 provides a pictorial view of how an ambulance trip is enhanced in accordance with one embodiment. Once the ambulance is ready to leave for its destination (e.g., patient location or hospital), the ambulance driver (or another operator either in the ambulance or from a remote location such as the cloud) enters/provides the destination address to the IoT device present (e.g., entered on a smartphone or another input device by tactile input, voice input, etc.) or installed in the ambulance (1). The cloud receives the address or route information from the ambulance IoT device (1). The IoT device may be securely authenticated by a cloud application (also referred to herein as a cloud-based logic) utilizing the identity of the IoT device, or another form of authentication to establish a secure communication channel between the IoT and the cloud.

Additionally, while some embodiments are discussed with reference to ambulances, the embodiments are not limited to ambulances and may include any authorized vehicle such as emergency service vehicles (including vehicles carrying security/police staff, medical personnel, firefighters, etc.), and/or vehicles carrying dignitaries, sensitive content (such as organs for organ transplants operations and/or hazardous material), etc.

After receiving this information, the cloud application prepares a list of traffic signals that need to be overridden to green as soon as the ambulance is in the vicinity of each traffic signal (appropriate time and/or distance). Accordingly, a threshold value for the time and/or distance between the ambulance and each traffic signal may be used to determine when to change the traffic signal to green (2, 3, 4). The cloud application may use the GPS (Global Positioning System) location of the ambulance to achieve this. Once the ambulance leaves a particular traffic signal (e.g., based on GPS and/or camera information provided from the traffic light, the ambulance, or other sources), the cloud application cancels the override operation at that traffic signal, resuming the traffic signal to its normal routine. IoT devices can also be installed at places where there is no traffic light (e.g., a 4-way stop intersection. etc.). In those places, the IoT device can detect an arriving ambulance and can alert pedestrians/people near the intersection to ease the ambulance movement (for example, in this case, ambulance may be too far away for its siren to be heard by the public, but the alarm sounds installed at the stop intersection will alert people much earlier that they can even hear the ambulance's siren).

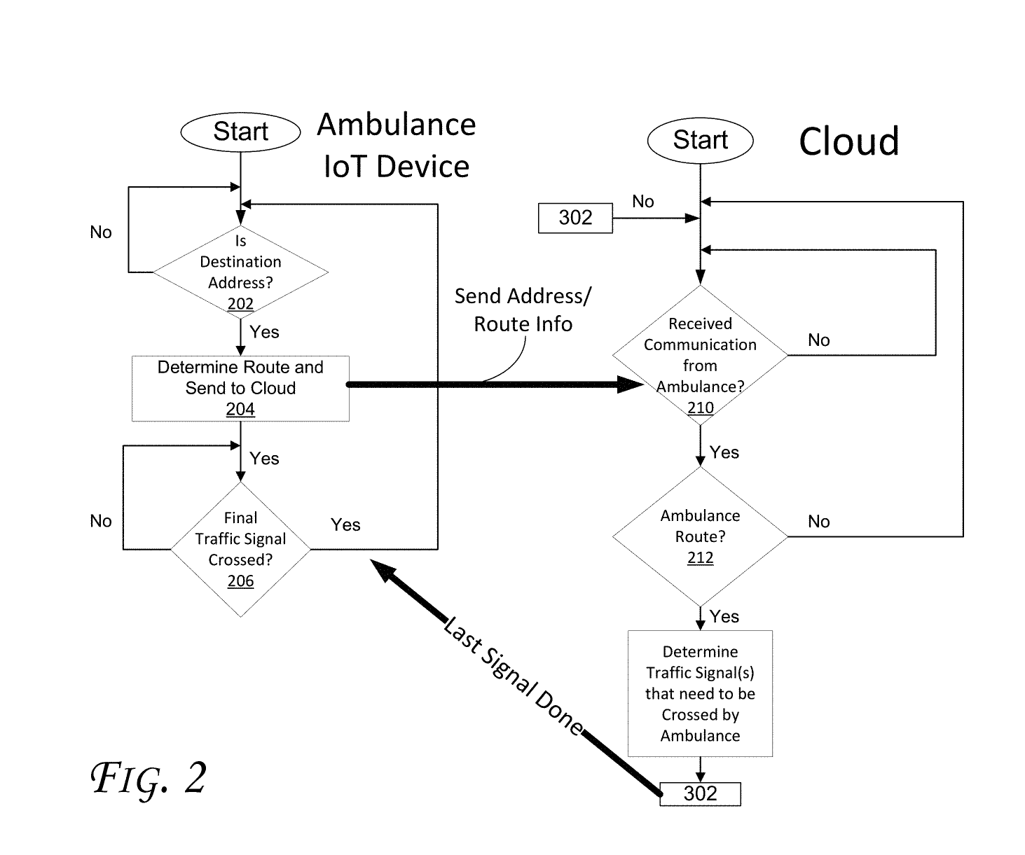

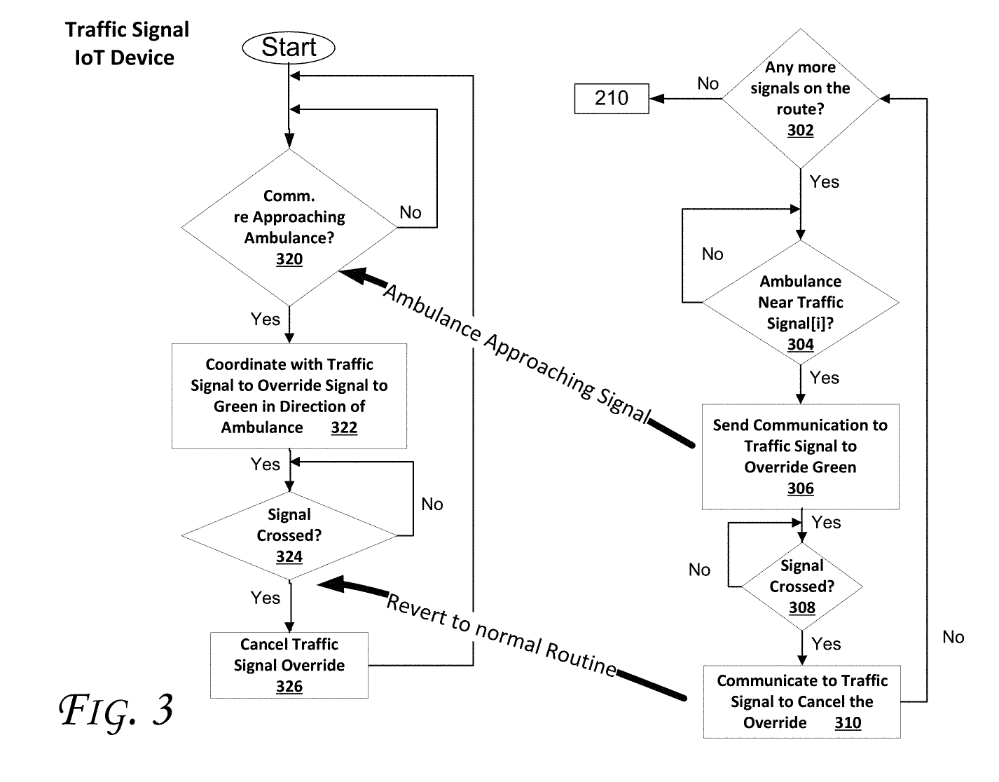

Once the ambulance reaches its destination, it is considered that that trip is completed and all applications (cloud and ambulance IoT) return to the default state and stay there until another incident is started by entering a new address by the ambulance driver or operator. In some embodiments, a single cloud infrastructure is capable of handling multiple on-duty ambulances in a city (or region) occurring in parallel, even from different hospitals, etc. For example, in case of multiple ambulances arriving at the same intersection at the same time, the cloud is able to “arbitrate” between them (e.g., based on first-come, first-serve priority) without any faulty operation at the traffic light controller. Integrated cameras on IoT devices (at the traffic light(s), on the ambulance, or other locations) may capture photos/videos of potential violators, which can then be sent to enforcement authorities for review/action. The full functional flow charts for each device (e.g., ambulance, traffic Signal, and cloud) are illustrated in FIGS. 2-3.

More particularly, FIGS. 2-3 illustrate flow diagrams of IoT and/or cloud enabled faster ambulances, according to some embodiments. In various embodiments, one or more components (including logic, a processor, memory, communication device, etc.) discussed herein with reference to FIGS. 1 and/or 4A-8 may be used to perform one or more operations discussed with reference to FIGS. 2 and/or 3.

Additionally, while some embodiments are discussed with reference to ambulances, the embodiments are not limited to ambulances and may include any authorized vehicle such as emergency service vehicles (including vehicles carrying security/police staff, medical personnel, firefighters, etc.), and/or vehicles carrying dignitaries, sensitive content (such as organs for organ transplants operations and/or hazardous material), etc.

Referring to FIGS. 1-2, operation 202 determines whether a destination address has been provided (e.g., via an input device (such as a keyboard, microphone, etc.) at the ambulance or from a remote location such as the cloud, a dispatch personnel or software application, etc.). The address may be any type of information that allows the ambulance to find a location, such as GPS coordinates, a traditional street address, cross streets, etc. Once the address is received, operation 204 determines the route from a present location of the ambulance (as determined by GPS information or per ambulance driver/operator feedback) to the destination. The route may be determined at the ambulance (e.g., using a GPS system), at a remote location or service (e.g., any of the navigation services available via wireless communication, such as smartphone applications, or IoT applications, etc.), or combinations thereof. User preferences or restrictions may also be taken into account such as avoiding or reducing exposure to certain road characteristics (e.g., toll roads, highways, surface streets, bridges, etc.). Once operation 204 is performed, the method waits for final traffic signal crossing at operation 206 before resetting to default settings and/or waiting for receipt of information regarding the next destination.

On the cloud side (e.g., via a cloud-based logic or application), operation 210 receives communication from the ambulance regarding the address/route information (per operation 204). Operation 212 determines whether the received destination information corresponds to a route for the ambulance. If the received destination information corresponds to the ambulance route, operation 214 determines the traffic signal(s) that are en route or otherwise need to be crossed by the ambulance on the way to the destination.

Referring to FIGS. 1-3, operation 302 determines whether any more traffic signals are en route and the method returns to operation 210 (e.g., in case of no signals on the route at all or all traffic signals having been crossed after operation 310 below). If more signals exist at operation 302, operation 304 determines whether the ambulance is near (e.g., based on some threshold time to travel and/or threshold distance) a traffic signal. Operation 306 sends a communication signal to the IoT device at (or otherwise coupled to) the traffic signal that is near the ambulance (as determined at operation 304) to override/cause the traffic signal to turn green to allow for passage of the ambulance. Once that traffic signal is crossed at operation 308 (e.g., determined based on GPS, camera information, etc. at the ambulance, traffic light, another location such as a remote operator monitoring cameras, camera installed at a location that is capable of monitoring the crossed intersection, etc.), operation 310 sends a signal to the traffic light to cancel the override of operation 306. The signal of operation 310 may be sent by an entity at the ambulance (such as a driver, another operator, the IoT device present on the ambulance), the cloud application, a remote operator monitoring the intersection, etc. Once no more signals are left after operation 310 (e.g., as determined by operation 302), the method returns to operation 210.

At the IoT device of each traffic signal, operation 320 awaits communication (e.g., from the cloud, ambulance, a remote operator, etc.) regarding an approaching ambulance (per operation 306). As discussed herein, “approaching” or “approachment” generally refers to a condition where a moving object is sufficiently close to or near (or more generally within a threshold distance from) a specific location of interest (such as traffic light, a traffic sign, an intersection, a light pole, or an illumination device) that certain actions may be initiated. When determining whether a moving object is approaching the specific location, the speed of the moving object may also be considered (e.g., a fast moving object may be considered to be approaching the specific location at a farther distance from the specific location than a slower moving object). At operation 322, the IoT device coordinates with the traffic signal control logic to override the signal to green in the travel direction of the ambulance. In an embodiment, traffic management information may be displayed (and/or audibly broadcast via speaker(s)) at or near the traffic light(s) to instruct the drivers to move away from the path of the ambulance at operation 322.

In various embodiments, the travel direction of the ambulance may be determined by the cloud (e.g., based on route information, GPS information received from the ambulance, and/or camera data (on the ambulance, traffic light, or at other location), by the ambulance (e.g., based on GPS and/or route information). Operation 324 determines whether the traffic signal has been crossed, e.g., based on communication per operation 310 from the cloud, communication from the ambulance, and/or as detected at the traffic signal based on camera information. As discussed herein, the location of an illumination device (such as traffic light, a traffic sign, an intersection, a light pole, or an illumination device) is considered to have been crossed based on one or more types of determinations. For example, a moving object (such as the ambulance discussed herein) may be considered as having crossed the location of an illumination device based on crossing: within a radius of the illumination device, a perpendicular line to the illumination device that crosses the street or intersection or walkway adjacent to the illumination device, etc. Once the traffic signal has been crossed, the traffic signal IoT cancels the traffic signal override at operation 326.

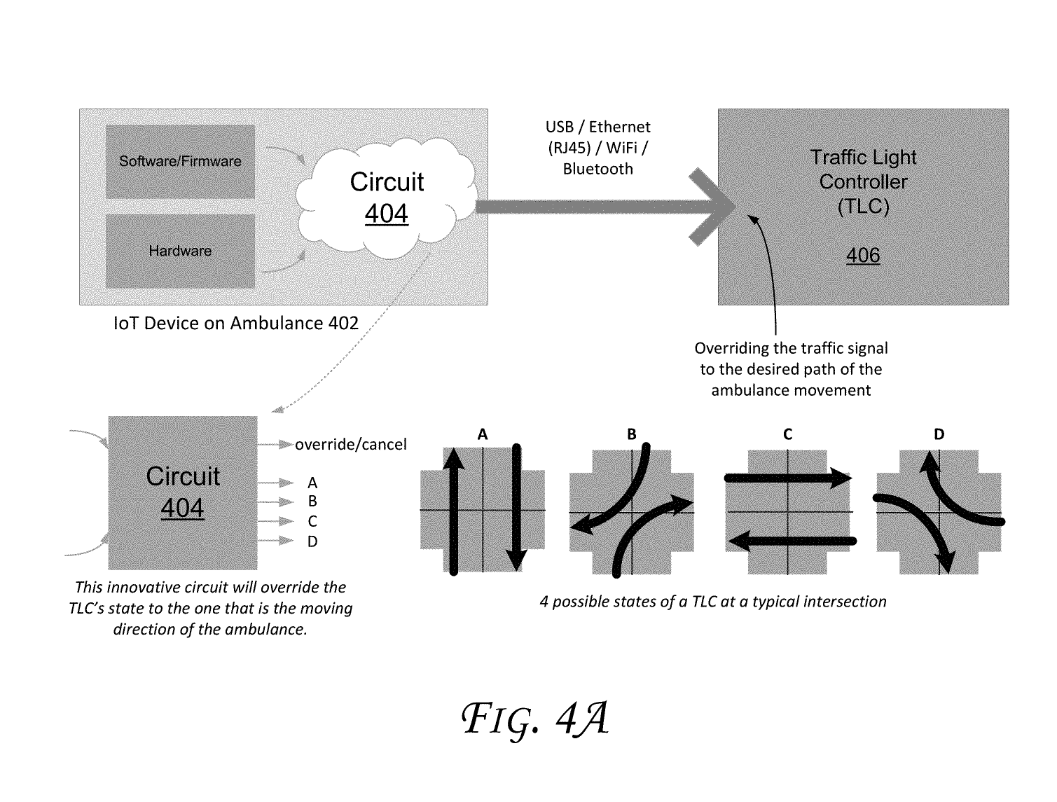

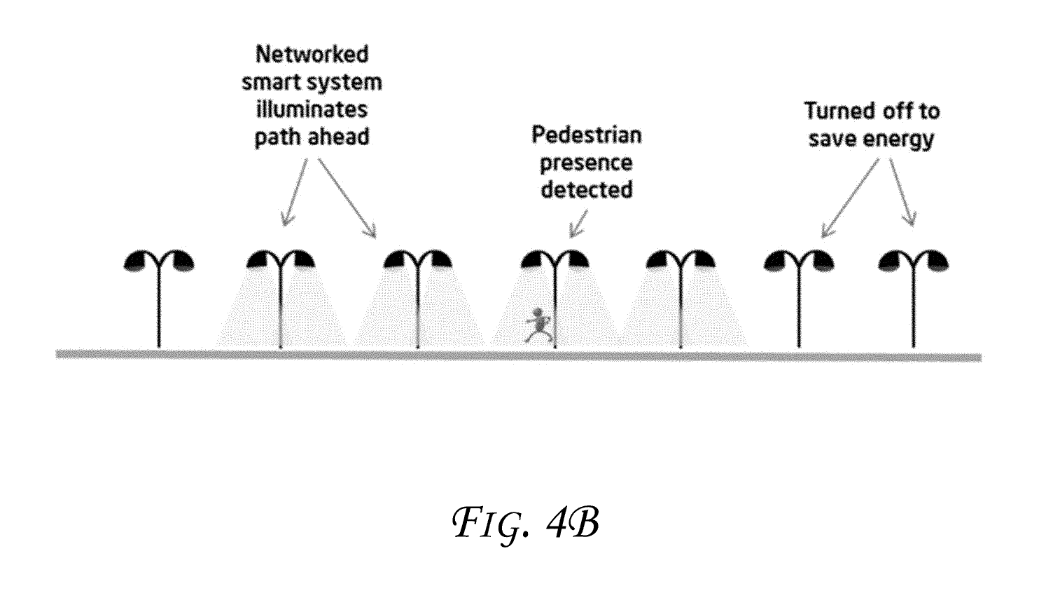

FIG. 4A illustrates communication between the ambulance IoT and a Traffic Light Controller (TLC), according to an embodiment. More particularly, when the ambulance is on the move, and is near a traffic light (e.g., 300 m or 500 m away, which is configurable in the system), the cloud communicates with the IoT device 402 at traffic light to indicate that the ambulance has arrived in the vicinity of the traffic light. The application or firmware (or more generally logic) running on the IoT device 402 performs the “override set” or “override cancel” operation. The illustrated circuit 404 (an implementation of this can be a decoder or demultiplexer in digital logic) subsequently causes the TLC 406 into a selected state (e.g., A, B, C, or D) of the traffic light (not shown). Moreover, some embodiments minimize the residency of the traffic light in the “override” state to reduce the negative (e.g., delay) effects on the cross traffic (which may be tunable for each traffic light individually).

FIG. 4B illustrates deployment of IoT devices at street lights, according to an embodiment. In one embodiment, IoT devices may be communicatively coupled to one or more street lights (e.g., every light, every other lights, etc.) to allow for control of the illumination at each street light (or more than one street light). Hence, power consumption saving by street lights can be achieved by a system of IoT devices and/or sensors of motion/video/radar/proximity and a smart centralized/localized control system. In an embodiment, illumination of the street lights may be controlled based on (GPS) information provided by a user's smartphone or wireless device, e.g., including an IoT device.

Moreover, one or more embodiments provide motion sensing, location data (e.g., based on GPS information, and/or video recognition, as well as network connectivity for each street lamp (or a group of lamps), for example, via the smart grid, local LAN (Local Area Network), WiFi (Wireless Protocol), or other protocol). In one embodiment, a smart control system (either localized or distributed) may then make decisions about which lamps need to be illuminated at any given time based on observed occupancy of the streets and sidewalks. This may include lamps that are some distance ahead/behind the detected occupancy that are not directly able to detect the occupancy themselves.

Further, the detection system (such as motion, video, radar, proximity, etc.) may be able to detect the presence of both vehicles and a pedestrian (including, for example, bicycles, skateboarders, etc.) and be able to discriminate between them. The system may also be able to track locations of people or groups of people as they progress along the sidewalk/roadside. This tracking may be coarse (e.g., perhaps just noticing as the group moves from one lamp-zone to another). The system would then illuminate some present number of lamps ahead of their path, and potentially similarly behind them (e.g., based on detected travel speed information). The actual illuminated distance could be based on pedestrian comfort. The actual illuminated distance could even be triggered by a smartphone.

Moreover, vehicle navigation systems could upload destination and/or route information to the control system which could then specifically illuminate the driver's route to their destination, e.g., even indicating upcoming turns by lighting the appropriate side-street. The coarse position tracking information could be used to track typical car speeds on given streets and be used to inform traffic enforcement about areas with (e.g., common) speeding or stop sign violations. Additionally (e.g., multicolored) LEDs (Light Emitting Diodes) and/or audio speakers in street lights may be used to signal traffic problems, hazards, iciness, and/or even to guide emergency/authorized vehicles. Also, while some embodiments refer to street lights herein, embodiments can also be applied to any type of light fixture such as lighting in or around a home, office, sports arena, etc.

Accordingly, some embodiments use IoT devices, communication over cellular networks, GPS, and/or cloud computing in a unique and superior way, which will provide: (1) timely control to override traffic signals to green when ambulance is in the vicinity; (2) secure authentication of communication of IoT devices (on ambulances or traffic signals) and the cloud; and/or (3) accurate tracking of the location of ambulance from GPS and overriding of traffic signal at a target level of vicinity (appropriate time and/or distance ahead).

Furthermore, some embodiments may be applied in computing devices that include one or more processors (e.g., with one or more processor cores), such as those discussed with reference to FIGS. 5-8, including for example small form factor or mobile computing devices, e.g., an IoT device, a smartphone, tablet, UMPC (Ultra-Mobile Personal Computer), laptop computer, Ultrabook™ computing device, wearable devices (such as a smart watch, smart glasses, etc.), 2 in 1 systems, etc. However, embodiments discussed herein are not limited to mobile computing devices and may be applied in any type of computing device, such as a work station, a server, a super computer, etc. Also, some embodiments are applied in computing devices that include a cooling fan as well as fanless computing devices.

In some embodiments, an IoT device may be utilized. An IoT device may include various components (such as one or more components discussed with reference to FIGS. 5-8). Also, one or more embodiments may utilize a computing cloud (or more generally a “cloud”). The computing cloud may include various types of computing devices (such as those discussed herein with reference to FIGS. 5-8). These devices may be in digital communication via a cellular communication channel, a computer network, and/or the Internet. Also, one or more of the components discussed herein can be embodied as a System On Chip (SOC) device. FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like.

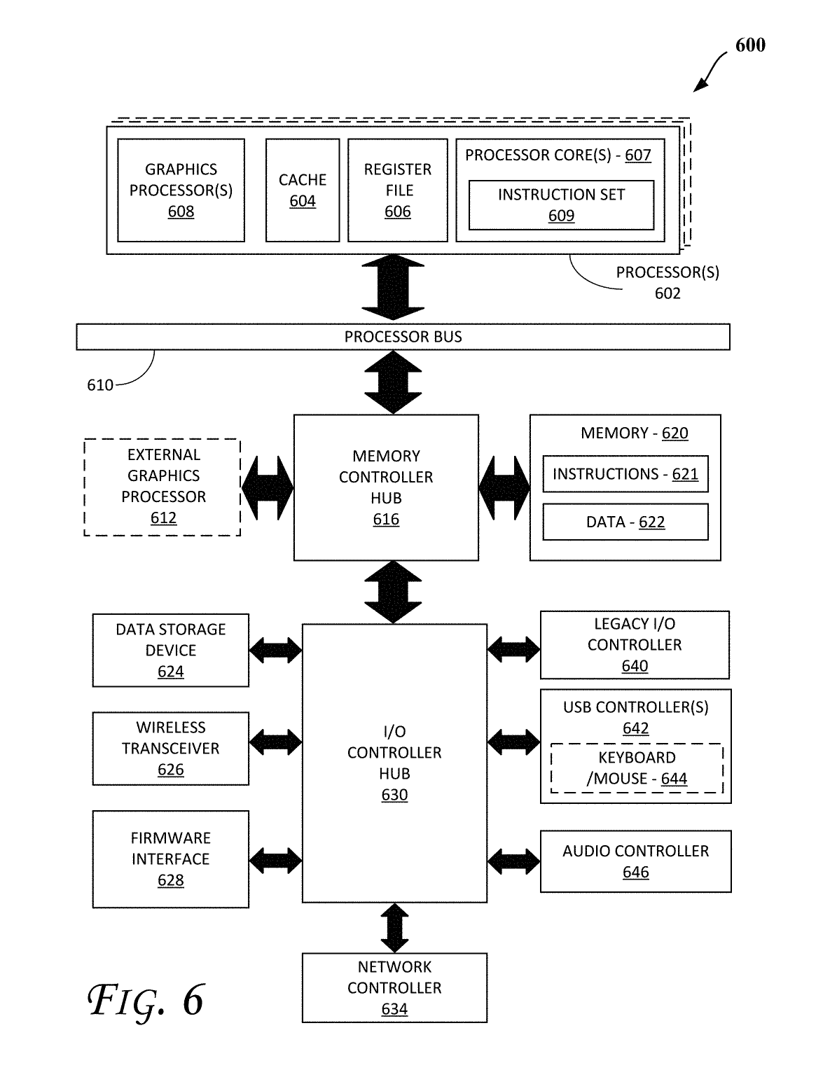

FIG. 6 is a block diagram of a processing system 600, according to an embodiment. In various embodiments the system 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC) integrated circuit for use in mobile, handheld, or embedded devices.

An embodiment of system 600 can include, or be incorporated within a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 609. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, processor 602 is coupled to a processor bus 610 to transmit communication signals such as address, data, or control signals between processor 602 and other components in system 600. In one embodiment the system 600 uses an exemplary ‘hub’ system architecture, including a memory controller hub 616 and an Input Output (I/O) controller hub 630. A memory controller hub 616 facilitates communication between a memory device and other components of system 600, while an I/O Controller Hub (ICH) 630 provides connections to I/O devices via a local I/O bus. In one embodiment, the logic of the memory controller hub 616 is integrated within the processor.

Memory device 620 can be a dynamic random access memory (DRAM) device, a static random access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 executes an application or process. Memory controller hub 616 also couples with an optional external graphics processor 612, which may communicate with the one or more graphics processors 608 in processors 602 to perform graphics and media operations.

In some embodiments, ICH 630 enables peripherals to connect to memory device 620 and processor 602 via a high-speed I/O bus. The I/O peripherals include, but are not limited to, an audio controller 646, a firmware interface 628, a wireless transceiver 626 (e.g., Wi-Fi, Bluetooth), a data storage device 624 (e.g., hard disk drive, flash memory, etc.), and a legacy I/O controller 640 for coupling legacy (e.g., Personal System 2 (PS/2)) devices to the system. One or more Universal Serial Bus (USB) controllers 642 connect input devices, such as keyboard and mouse 644 combinations. A network controller 634 may also couple to ICH 630. In some embodiments, a high-performance network controller (not shown) couples to processor bus 610. It will be appreciated that the system 600 shown is exemplary and not limiting, as other types of data processing systems that are differently configured may also be used. For example, the I/O controller hub 630 may be integrated within the one or more processor 602, or the memory controller hub 616 and I/O controller hub 630 may be integrated into a discreet external graphics processor, such as the external graphics processor 612.

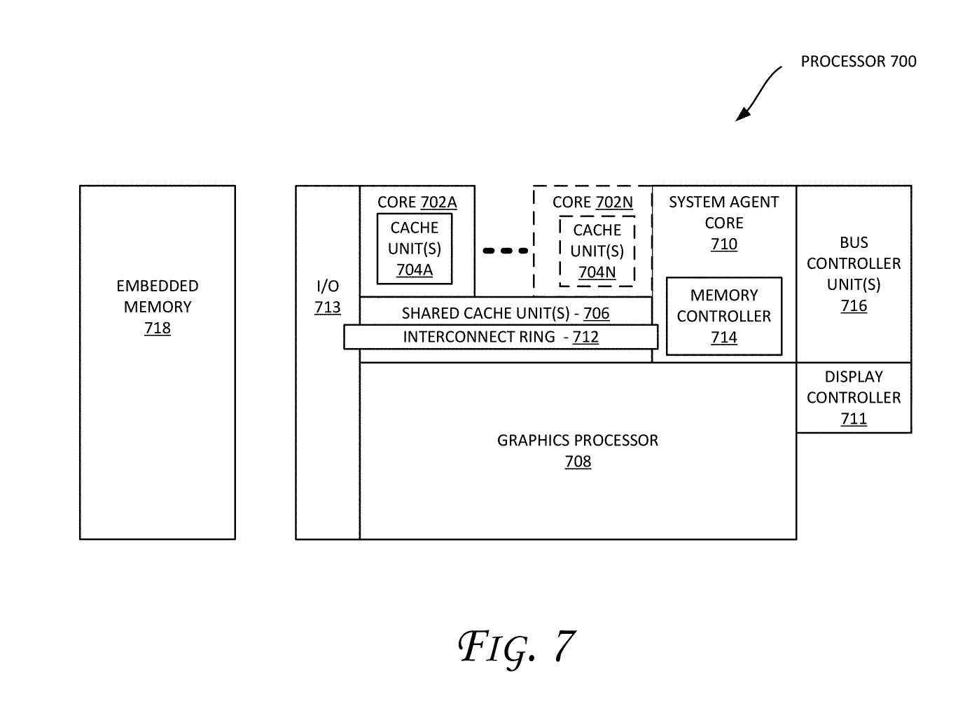

FIG. 7 is a block diagram of an embodiment of a processor 700 having one or more processor cores 702A-702N, an integrated memory controller 714, and an integrated graphics processor 708. Those elements of FIG. 7 having the same reference numbers (or names) as the elements of any other figure herein can operate or function in any manner similar to that described elsewhere herein, but are not limited to such. Processor 700 can include additional cores up to and including additional core 702N represented by the dashed lined boxes. Each of processor cores 702A-702N includes one or more internal cache units 704A-704N. In some embodiments each processor core also has access to one or more shared cached units 706.

The internal cache units 704A-704N and shared cache units 706 represent a cache memory hierarchy within the processor 700. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 706 and 704A-704N.

In some embodiments, processor 700 may also include a set of one or more bus controller units 716 and a system agent core 710. The one or more bus controller units 716 manage a set of peripheral buses, such as one or more Peripheral Component Interconnect buses (e.g., PCI, PCI Express). System agent core 710 provides management functionality for the various processor components. In some embodiments, system agent core 710 includes one or more integrated memory controllers 714 to manage access to various external memory devices (not shown).

In some embodiments, one or more of the processor cores 702A-702N include support for simultaneous multi-threading. In such embodiment, the system agent core 710 includes components for coordinating and operating cores 702A-702N during multi-threaded processing. System agent core 710 may additionally include a power control unit (PCU), which includes logic and components to regulate the power state of processor cores 702A-702N and graphics processor 708.

In some embodiments, processor 700 additionally includes graphics processor 708 to execute graphics processing operations. In some embodiments, the graphics processor 708 couples with the set of shared cache units 706, and the system agent core 710, including the one or more integrated memory controllers 714. In some embodiments, a display controller 711 is coupled with the graphics processor 708 to drive graphics processor output to one or more coupled displays. In some embodiments, display controller 711 may be a separate module coupled with the graphics processor via at least one interconnect, or may be integrated within the graphics processor 708 or system agent core 710.

In some embodiments, a ring based interconnect unit 712 is used to couple the internal components of the processor 700. However, an alternative interconnect unit may be used, such as a point-to-point interconnect, a switched interconnect, or other techniques, including techniques well known in the art. In some embodiments, graphics processor 708 couples with the ring interconnect 712 via an I/O link 713.

The exemplary I/O link 713 represents at least one of multiple varieties of I/O interconnects, including an on package I/O interconnect which facilitates communication between various processor components and a high-performance embedded memory module 718, such as an eDRAM (or embedded DRAM) module. In some embodiments, each of the processor cores 702-702N and graphics processor 708 use embedded memory modules 718 as a shared Last Level Cache.

In some embodiments, processor cores 702A-702N are homogenous cores executing the same instruction set architecture. In another embodiment, processor cores 702A-702N are heterogeneous in terms of instruction set architecture (ISA), where one or more of processor cores 702A-702N execute a first instruction set, while at least one of the other cores executes a subset of the first instruction set or a different instruction set. In one embodiment processor cores 702A-702N are heterogeneous in terms of microarchitecture, where one or more cores having a relatively higher power consumption couple with one or more power cores having a lower power consumption. Additionally, processor 700 can be implemented on one or more chips or as an SoC integrated circuit having the illustrated components, in addition to other components.

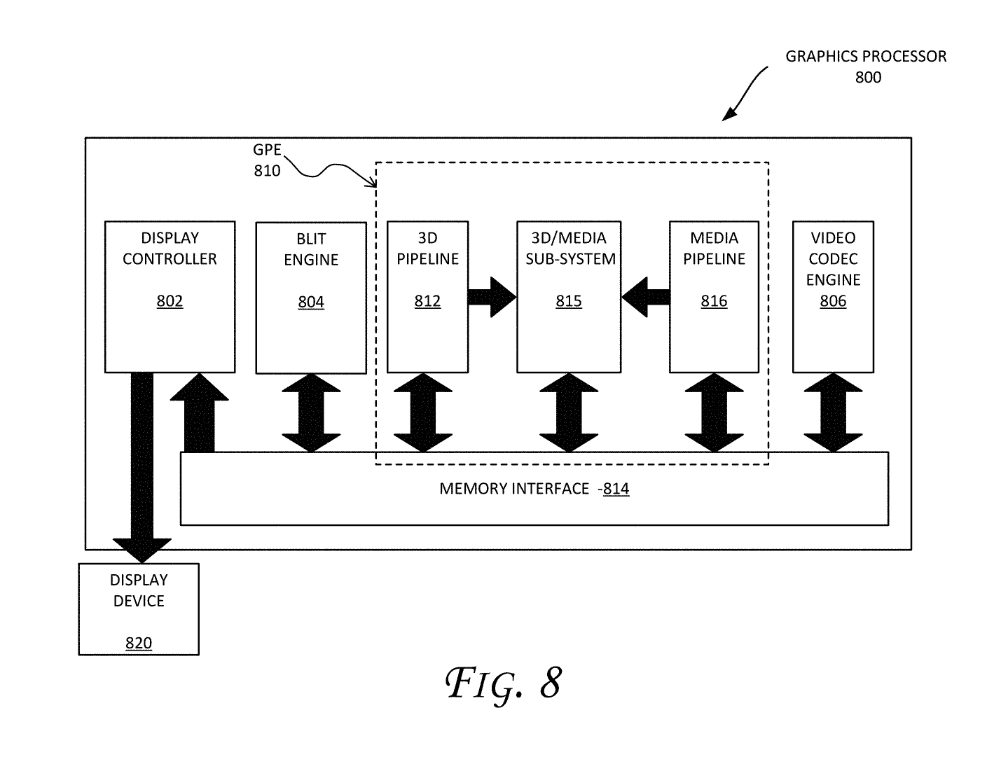

FIG. 8 is a block diagram of a graphics processor 800, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 800 includes a memory interface 814 to access memory. Memory interface 814 can be an interface to local memory, one or more internal caches, one or more shared external caches, and/or to system memory.

In some embodiments, graphics processor 800 also includes a display controller 802 to drive display output data to a display device 820. Display controller 802 includes hardware for one or more overlay planes for the display and composition of multiple layers of video or user interface elements. In some embodiments, graphics processor 800 includes a video codec engine 806 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 800 includes a block image transfer (BLIT) engine 804 to perform two-dimensional (2D) rasterizer operations including, for example, bit-boundary block transfers. However, in one embodiment, 8D graphics operations are performed using one or more components of graphics processing engine (GPE) 810. In some embodiments, graphics processing engine 810 is a compute engine for performing graphics operations, including three-dimensional (3D) graphics operations and media operations.

In some embodiments, GPE 810 includes a 3D pipeline 812 for performing 3D operations, such as rendering three-dimensional images and scenes using processing functions that act upon 3D primitive shapes (e.g., rectangle, triangle, etc.). The 3D pipeline 812 includes programmable and fixed function elements that perform various tasks within the element and/or spawn execution threads to a 3D/Media sub-system 815. While 3D pipeline 812 can be used to perform media operations, an embodiment of GPE 810 also includes a media pipeline 816 that is specifically used to perform media operations, such as video post-processing and image enhancement.

In some embodiments, media pipeline 816 includes fixed function or programmable logic units to perform one or more specialized media operations, such as video decode acceleration, video de-interlacing, and video encode acceleration in place of, or on behalf of video codec engine 806. In some embodiments, media pipeline 816 additionally includes a thread spawning unit to spawn threads for execution on 3D/Media sub-system 815. The spawned threads perform computations for the media operations on one or more graphics execution units included in 3D/Media sub-system 815.

In some embodiments, 3D/Media subsystem 815 includes logic for executing threads spawned by 3D pipeline 812 and media pipeline 816. In one embodiment, the pipelines send thread execution requests to 3D/Media subsystem 815, which includes thread dispatch logic for arbitrating and dispatching the various requests to available thread execution resources. The execution resources include an array of graphics execution units to process the 3D and media threads. In some embodiments, 3D/Media subsystem 815 includes one or more internal caches for thread instructions and data. In some embodiments, the subsystem also includes shared memory, including registers and addressable memory, to share data between threads and to store output data.

The following examples pertain to further embodiments. Example 1 may optionally include an apparatus comprising: an IoT (Internet of Things) device coupled to an illumination device to override an operating state of the illumination device based at least in part on a wireless signal that is to indicate approachment of a moving object, wherein the IoT device is to cancel the override of the operating state of the illumination device based at least in part on an indication that the moving object has crossed a location of the illumination device. Example 2 may optionally include the apparatus of example 1, wherein the wireless signal is to be transmitted by cloud-based logic. Example 3 may optionally include the apparatus of example 2, wherein the cloud-based logic is to determine the illumination device as a candidate whose operating state is to be overridden based on information corresponding to a travel direction of the moving object. Example 4 may optionally include the apparatus of example 2, wherein the cloud-based logic is to cause override of operating states of a plurality of illumination devices on a travel path of the moving object. Example 5 may optionally include the apparatus of example 4, wherein the cloud-based logic is to determine the plurality of illumination devices based on information regarding a travel direction of the moving object. Example 6 may optionally include the apparatus of example 1, wherein the moving object is to comprise one or more authorized vehicles or at least one pedestrian. Example 7 may optionally include the apparatus of example 6, wherein the authorized vehicle is to comprise an emergency service vehicle, a vehicle carrying a dignitary, or a vehicle carrying sensitive content. Example 8 may optionally include the apparatus of example 1, wherein the indication is to be detected based on one or more of: motion, video, radar, or proximity. Example 9 may optionally include the apparatus of example 1, wherein the override of the operating state of the illumination device is to allow for passage of the moving object. Example 10 may optionally include the apparatus of example 1, wherein the override of the operating state of the illumination device is to illuminate a path of the moving object. Example 11 may optionally include the apparatus of example 1, wherein the illumination device is to comprise one or more of: a traffic light, a street light, and a light fixture. Example 12 may optionally include the apparatus of example 1, wherein the illumination device is to house the IoT device. Example 13 may optionally include the apparatus of example 1, wherein the IoT device is to comprise: processing logic, memory, and a network communication device.

Example 14 may optionally include an apparatus comprising: cloud-based logic to determine one or more illumination devices that are on a travel path of a moving object, wherein the cloud-based logic is to cause an override to an operating state of each of the one or more illumination devices through one or more IoT devices coupled to the one or more illumination devices, wherein the cloud-based logic is to cause the override based at least in part on a wireless signal that is to indicate approachment of the moving object, wherein the IoT device is to cancel the override of the operating state based at least in part on an indication that the moving object has crossed a location of a corresponding illumination device. Example 15 may optionally include the apparatus of example 14, wherein the wireless signal is to be transmitted by the cloud-based logic. Example 16 may optionally include the apparatus of example 14, wherein the cloud-based logic is to determine the illumination device as a candidate whose operating state is to be overridden based on information corresponding to a travel direction of the moving object. Example 17 may optionally include the apparatus of example 14, wherein the moving object is to comprise one or more authorized vehicles or at least one pedestrian. Example 18 may optionally include the apparatus of example 17, wherein the authorized vehicle is to comprise an emergency service vehicle, a vehicle carrying a dignitary, or a vehicle carrying sensitive content. Example 19 may optionally include the apparatus of example 14, wherein the indication is to be detected based on one or more of: motion, video, radar, or proximity. Example 20 may optionally include the apparatus of example 14, wherein the override of the operating state is to allow for passage of the moving object. Example 21 may optionally include the apparatus of example 14, wherein the override of the operating state is to illuminate a path of the moving object. Example 22 may optionally include the apparatus of example 14, wherein the illumination device is to comprise one or more of: a traffic light, a street light, and a light fixture.

Example 23 may optionally include a method comprising: overriding an operating state of an illumination device via an IoT (Internet of Things) device based at least in part on a wireless signal that indicates approachment of a moving object; and the IoT device cancelling the override of the operating state of the illumination device based at least in part on an indication that the moving object has crossed a location of the illumination device. Example 24 may optionally include the method of example 23, further comprising cloud-based logic transmitting the wireless signal. Example 25 may optionally include the method of example 24, further comprising cloud-based logic determining the illumination device as a candidate whose operating state is to be overridden based on information corresponding to a travel direction of the moving object. Example 26 may optionally include the method of example 24, further comprising the cloud-based logic causing override of operating states of a plurality of illumination devices on a travel path of the moving object. Example 27 may optionally include the method of example 26, further comprising the cloud-based logic determining the plurality of illumination devices based on information regarding a travel direction of the moving object. Example 28 may optionally include the method of example 23, wherein the moving object comprises one or more authorized vehicles or at least one pedestrian. Example 29 may optionally include the method of example 28, wherein the authorized vehicle comprises an emergency service vehicle, a vehicle carrying a dignitary, or a vehicle carrying sensitive content. Example 30 may optionally include the method of example 23, further comprising detecting the indication based on one or more of: motion, video, radar, or proximity. Example 31 may optionally include the method of example 23, further comprising the override of the operating state of the illumination device allowing for passage of the moving object. Example 32 may optionally include the method of example 23, further comprising the override of the operating state of the illumination device illuminating a path of the moving object. Example 33 may optionally include the method of example 23, wherein the illumination device comprises one or more of: a traffic light, a street light, and a light fixture.

Example 34 may optionally include an apparatus comprising means to perform a method as set forth in any preceding example. Example 35 comprises machine-readable storage including machine-readable instructions, when executed, to implement a method or realize an apparatus as set forth in any preceding example.

In various embodiments, the operations discussed herein, e.g., with reference to FIGS. 1-8, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-8.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
an IoT (Internet of Things) device coupled to an illumination device to override an operating state of the illumination device based at least in part on a wireless signal that is to indicate approachment of a moving object,
wherein the IoT device is to cancel the override of the operating state of the illumination device based at least in part on an indication that the moving object has crossed a location of the illumination device.

2. The apparatus of claim 1, wherein the wireless signal is to be transmitted by cloud-based logic.

3. The apparatus of claim 2, wherein the cloud-based logic is to determine the illumination device as a candidate whose operating state is to be overridden based on information corresponding to a travel direction of the moving object.

4. The apparatus of claim 2, wherein the cloud-based logic is to cause override of operating states of a plurality of illumination devices on a travel path of the moving object.

5. The apparatus of claim 4, wherein the cloud-based logic is to determine the plurality of illumination devices based on information regarding a travel direction of the moving object.

6. The apparatus of claim 1, wherein the moving object is to comprise one or more authorized vehicles or at least one pedestrian.

7. The apparatus of claim 6, wherein the authorized vehicle is to comprise an emergency service vehicle, a vehicle carrying a dignitary, or a vehicle carrying sensitive content.

8. The apparatus of claim 1, wherein the indication is to be detected based on one or more of: motion, video, radar, or proximity.

9. The apparatus of claim 1, wherein the override of the operating state of the illumination device is to allow for passage of the moving object.

10. The apparatus of claim 1, wherein the override of the operating state of the illumination device is to illuminate a path of the moving object.

11. The apparatus of claim 1, wherein the illumination device is to comprise one or more of: a traffic light, a street light, and a light fixture.

12. The apparatus of claim 1, wherein the illumination device is to house the IoT device.

13. The apparatus of claim 1, wherein the IoT device is to comprise: processing logic, memory, and a network communication device.

14. An apparatus comprising:
cloud-based logic to determine one or more illumination devices that are on a travel path of a moving object,
wherein the cloud-based logic is to cause an override to an operating state of each of the one or more illumination devices through one or more IoT devices coupled to the one or more illumination devices, wherein the cloud-based logic is to cause the override based at least in part on a wireless signal that is to indicate approachment of the moving object,
wherein the IoT device is to cancel the override of the operating state based at least in part on an indication that the moving object has crossed a location of a corresponding illumination device.

15. The apparatus of claim 14, wherein the wireless signal is to be transmitted by the cloud-based logic.

16. The apparatus of claim 14, wherein the cloud-based logic is to determine the illumination device as a candidate whose operating state is to be overridden based on information corresponding to a travel direction of the moving object.

17. The apparatus of claim 14, wherein the moving object is to comprise one or more authorized vehicles or at least one pedestrian.

18. The apparatus of claim 17, wherein the authorized vehicle is to comprise an emergency service vehicle, a vehicle carrying a dignitary, or a vehicle carrying sensitive content.

19. The apparatus of claim 14, wherein the indication is to be detected based on one or more of: motion, video, radar, or proximity.

20. The apparatus of claim 14, wherein the override of the operating state is to allow for passage of the moving object.

21. The apparatus of claim 14, wherein the override of the operating state is to illuminate a path of the moving object.

22. The apparatus of claim 14, wherein the illumination device is to comprise one or more of: a traffic light, a street light, and a light fixture.

23. A method comprising:
overriding an operating state of an illumination device via an IoT (Internet of Things) device based at least in part on a wireless signal that indicates approachment of a moving object; and
the IoT device cancelling the override of the operating state of the illumination device based at least in part on an indication that the moving object has crossed a location of the illumination device.

24. The method of claim 23, further comprising cloud-based logic transmitting the wireless signal.

25. The method of claim 24, further comprising cloud-based logic determining the illumination device as a candidate whose operating state is to be overridden based on information corresponding to a travel direction of the moving object.
